(19) United States
(12) Patent Application Publication
(10) Pub. No.: US 2022/0281673 A1
(43) Pub. Date: Sep. 8, 2022

(54) Glove Dispensing Container

(71) Applicant: Mona Harp, Dallas, GA (US)

(72) Inventor: Mona Harp, Dallas, GA (US)

(21) Appl. No.: 17/580,711

(22) Filed: Jan. 21, 2022

Related U.S. Application Data
(60) Provisional application No. 63/155,975, filed on Mar. 3, 2021.

(51) Int. Cl. B65D 83/08; B65D 43/16

(52) U.S. Cl. CPC B65D 83/0805; B65D 43/163; B65D 83/0894

(57) ABSTRACT

A glove dispensing container is provided. The device includes a container body having an upper wall, a lower wall, and a perimeter sidewall defining an interior volume. A slot is disposed centrally through the upper wall of the container body, wherein the slot provides access to the interior volume. A plurality of disposable gloves disposed within the interior volume, wherein the slot is dimensioned to dispense a disposable glove of the plurality of disposable gloves therethrough. A lid is hingedly affixed to a rear edge of the upper wall of the container body, wherein the lid selectively moves between an open position and a closed position. Indicia is disposed across an exterior surface of the container body. In some embodiments, a display is disposed on an upper surface of the lid, wherein the display is in communication with a remote device to receive a plurality of images to display.

### CROSS REFERENCE TO RELATED APPLICATIONS

This application claims the benefit of U.S. Provisional Application No. 63/155,975 filed on Mar. 3, 2021. The above identified patent application is herein incorporated by reference in its entirety to provide continuity of disclosure.

### BACKGROUND OF THE INVENTION

The present invention relates to a glove dispensing container. More particularly, the present invention pertains to a glove dispensing container for securement in a vehicle, wherein the container includes indicia or a display on the exterior to allow a user to personalize the glove dispensing container.

Many individuals personally refuel their vehicles at gas stations regularly and frequently. However, when pumping gasoline by hand, gasoline residue may be transferred from the pump to the user's hand, which can pose several issues. Primarily, gasoline has a distinctive odor many individuals find offensive, and due to the nature of gasoline, removing such an odor may require repeated vigorous hand washing. Additionally, the residue may further be transferred to the interior of the vehicle upon driving from the gas station, making the odor more pervasive and difficult to remove. Furthermore, frequently contacting publicly accessible fuel pumps may allow germs, bacteria, and viruses to be transferred to the user, potentially risking contracting an illness. Therefore, a device that provides a hand covering suitable for use with gasoline pumps that can further be customized to suit the user's preferences is desired.

In light of the devices disclosed in the known art, it is submitted that the present invention substantially diverges in design elements from the known art and consequently it is clear that there is a need in the art for an improvement to existing glove dispensing containers. In this regard, the instant invention substantially fulfills these needs.

### SUMMARY OF THE INVENTION

In view of the foregoing disadvantages inherent in the known types of glove dispensing containers now present in the known art, the present invention provides a personalized glove dispensing container securable within a vehicle wherein the same can be utilized for providing convenience for the user when pumping gasoline or performing other activities where hand protection is desired within proximity of a vehicle.

The present system comprises a container body having an upper wall, a lower wall, and a perimeter sidewall defining an interior volume. A slot is disposed centrally through the upper wall of the container body, wherein the slot provides access to the interior volume. A plurality of disposable gloves is disposed within the interior volume, wherein the slot is dimensioned to dispense a disposable glove of the plurality of disposable gloves therethrough. A lid is hingedly affixed to a rear edge of the upper wall of the container body, wherein the lid selectively moves between an open position and a closed position, wherein the closed position the lid overlies the slot to enclose the interior volume. Indicia is disposed across an exterior surface of the container body. In some embodiments, a display is disposed on an upper surface of the lid, wherein the display includes a non-transitory computer readable memory and a wireless transceiver in wireless communication with a remote device. The non-transitory computer readable memory stores a plurality of images received from the remote device, wherein the display is configured to display one or more selected images from the plurality of images.

In some embodiments, the plurality of disposable gloves are interwoven in a stacked configuration, such that upon dispensing a disposable glove through the slot, an adjacent disposable glove is partially disposed through the slot. In another embodiment, the plurality of disposable gloves comprise a material configured to be chemically inert with respect to gasoline. In other embodiments, the container body comprises an upper portion hingedly affixed to a lower portion. In yet another embodiment, a latch is disposed on the lid, wherein the latch retains the lid in the closed position. In some embodiments, the latch frictionally engages within a recess disposed within the upper wall of the container body. In another embodiment, a button is disposed on the upper wall, whereupon actuation of the button, the latch is disengaged. In other embodiments, a fastener is disposed on a lower surface of the lower wall, wherein the fastener removably secures the container body to a support surface. In yet another embodiment, an upper surface of the lid rests flush with an exterior of the upper wall of the container body when the lid is in the closed position. In some embodiments, the lid is disposed centrally along the upper wall and comprises a smaller cross-sectional area than the upper wall of the container body.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the glove dispensing container with the lid in an open position.

FIG. 1B shows a perspective view of an embodiment of the glove dispensing container with the lid in a closed position.

FIG. 2 shows a lower plan view of an embodiment of the glove dispensing container.

FIG. 3 shows a cross-sectional view of an embodiment of the glove dispensing container.

FIG. 4 shows a perspective view of an embodiment of the glove dispensing container in an open position.

FIG. 5 shows a schematic view of an embodiment of the display of the glove dispensing container.

### DETAILED DESCRIPTION OF THE INVENTION

Reference is made herein to the attached drawings. Like reference numerals are used throughout the drawings to depict like or similar elements of the glove dispensing container. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

As referred to herein, the term “electronic device” refers to any computing device that includes at least a display screen and an input mechanism. The computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such computing devices can also combine custom hard-wired logic, ASICs, or FPGAs with custom programming to accomplish the technique and other features of the present disclosure. The computing devices can be desktop computer systems, laptops, cell phones, tablets, networking devices, or any other device that incorporates hard-wired and/or program logic to implement the techniques and other features of the present disclosure.

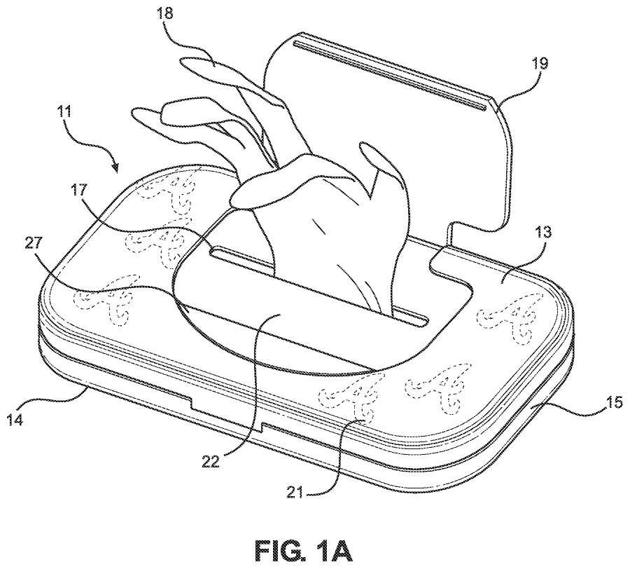

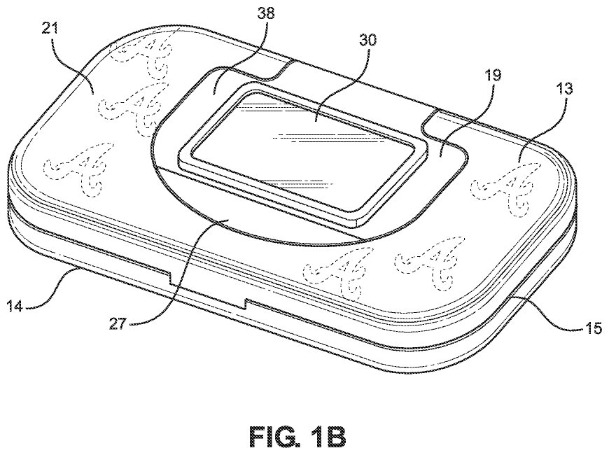

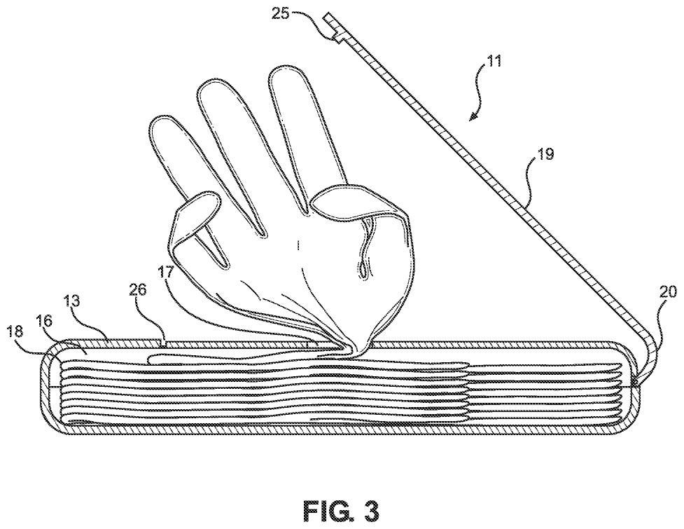

Referring now to FIGS. 1A and 1B, there is shown a perspective view of an embodiment of the glove dispensing container with the lid in an open position and a perspective view of an embodiment of the glove dispensing container with the lid in a closed position, respectively. The glove dispensing container 11 comprises a container body having an upper wall 13, a lower wall 14, and a perimeter sidewall 15 therearound defining an interior volume (as shown in FIG. 3, 16). The glove dispensing container 11 is contemplated to store a plurality of disposable gloves 18 within the interior volume, wherein each glove of the plurality of disposable gloves 18 is individually dispensed through a slot 17 disposed through the upper wall 13. In the illustrated embodiment, the slot 17 is disposed centrally through the upper wall 13 and extends along a longitudinal axis of the container body. The slot 17 provides access to the interior volume of the container body and is dimensioned to receive a single glove of the plurality of disposable gloves 18 therethrough. The plurality of disposable gloves 18 are contemplated to comprise a material chemically inert with respect to gasoline, such that the plurality of disposable gloves 18 do not degrade in contact with gasoline. In this manner, the glove dispensing container 11 can provide a plurality of single use disposable gloves 18 to prevent the user contacting gasoline when refueling their vehicle, while also protecting the user from surface borne pathogens.

A lid 19 is hingedly affixed to a rear edge of the upper wall 13, wherein the lid 19 selectively moves between an open position (as shown in FIG. 1A) and a closed position (as shown in FIG. 1B). When in the closed position, the lid 19 overlies the slot 17, such that the interior volume is entirely enclosed thereby. In the shown embodiment, the upper wall 13 comprises an indented portion configured to receive the lid 19 therein, such that an upper surface 38 of the lid 19 rests flush with an exterior surface 22 of the upper wall 13. In this manner, the form factor of the glove dispensing container 11 is minimized to provide convenience in transport and storage thereof. In the shown embodiment, the lid 19 comprises a smaller cross-sectional area than the upper wall 13 and tapers from a front end thereof to a rear end thereof, wherein the rear end is adjacent to the rear edge of the upper wall 13, such that the rear end comprises a length less than that of the front end. Furthermore, in the illustrated embodiment, the lid 19 includes a latch (as shown in FIG. 3, 25) on a lower surface thereof, wherein the latch engages the upper wall 13 to retain the lid 19 in the closed position. In some such embodiments, a button 27 is disposed on the upper wall 13, wherein the button 27 is in operable communication with the latch when the lid 19 is in the closed position, such that upon actuation of the button 27, the latch disengages the upper wall 13 allowing the lid 19 to transition to the open position. In the shown embodiment, the button 27 rests flush with the exterior surface 22 of the upper wall 13 when not actuated providing a contiguous exterior surface 22. In the illustrated embodiment, the front end of the lid 19 comprises a linear edge configured to abut the button 27 when in the closed position.

In the shown embodiment, indicia 21 are disposed across the exterior surface 22 of the container body, such that the glove dispensing container 11 can be customized to suit a user's desired preferences. Additionally, the indicia 21 are contemplated to extend across an entirety of the upper wall 13 and the lower wall 14, such that the entire exterior surface 22 comprises indicia 21 thereon. Furthermore, in the shown embodiment, the indicia 21 comprise an identical image evenly distributed across the exterior surface 22. In the illustrated embodiment, a display 30 is affixed to an upper surface 38 of the lid 19, wherein the display 30 is configured to display one or more of a plurality of images, videos, or other media thereon as further described elsewhere herein. In some embodiments, the display 30 is coextensive with the upper surface 38, such that the display 30 is configured to conform to the shape and size of the lid 19. In some embodiments, the display 30 further comprises a processor and memory therein, such that the display 30 comprises a self-contained media platform, whereas, in alternate embodiments, the display 30 is in wireless communication with a remote device, wherein media is streamed or downloaded to the display 30 from the remote device. In this manner, the display 30 provides the user with further customization and entertainment options when the lid 19 is in the closed position.

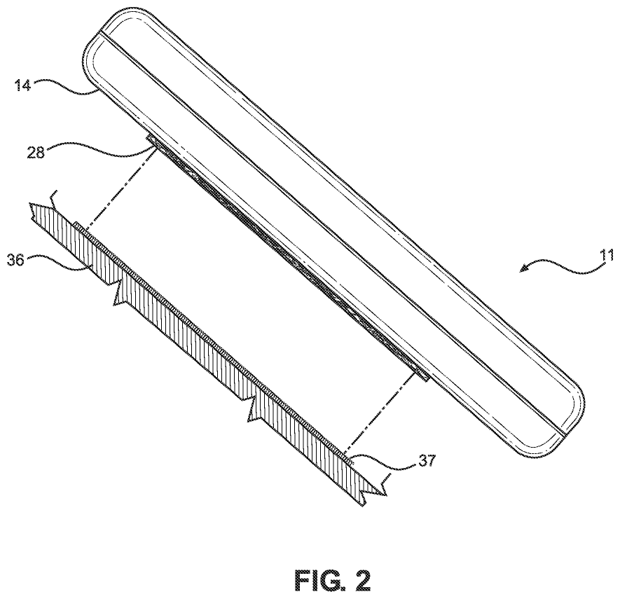

Referring now to FIG. 2, there is shown a lower plan view of an embodiment of the glove dispensing container. In the shown embodiment, a fastener 28 is disposed across a lower surface of the lower wall 14, wherein the fastener 28 is contemplated to removably secure the glove dispensing container 11 to a support surface 36, such as a vehicle dashboard, central console, or the like. In this manner, the glove dispensing container 11 is readily accessible within the cabin of the vehicle, such that the plurality of disposable gloves can be dispensed and used as necessary to prevent the spread of pathogens, gasoline, or other undesired or unsanitary trace materials transferred to a user's hand. In the shown embodiment, the fastener 28 comprises a hook and loop fastener removably securable to a complementary fastener 37 affixed to the support surface 36. In alternate embodiments, the fastener 28 is contemplated to comprise alternate fastening means, such as reusable adhesives which can further comprise a removable backing material overlying the fastener 28 to preserve the efficacy of the adhesive until use.

Referring now to FIG. 3, there is shown a cross-sectional view of an embodiment of the glove dispensing container. In the illustrated embodiment, the plurality of disposable gloves 18 are disposed within the interior volume 16 of the glove dispensing container 11 in a stacked and interwoven configuration, such that upon dispensing a single disposable glove through the slot 17, an adjacent glove of the plurality of disposable gloves 18 is partially dispensed through the slot 17. In this manner, each dispensed glove feeds a new glove through the slot 17 to dispense gloves efficiently and easily through the slot 17. In the illustrated embodiment, the lid 19 is hingedly affixed to the upper wall 13 along a rear edge 20 thereof, such that the lid 19 is selectively movable between an open position and a closed position. In some embodiments, the upper wall 13 comprises an indented portion configured to receive the lid 19 therein, such that the upper surface of the lid 19 rests flush with an exterior surface of the upper wall 13 when the lid 19 is in the closed position. In some such embodiments, a lower side of the lid 19 is concave, such that a glove partially dispensed through the slot 17 is retained within the concavity of the lid 19, ensuring that the partially dispensed glove does not interfere with the securement of the lid 19 in the closed position. Additionally, in the shown embodiment, the lid 19 further comprises a latch 25 on a lower side thereof, wherein the latch 25 frictionally engages the upper wall 13 of the glove dispensing container 11 to retain the lid 19 in the closed position. In some embodiments, the latch 25 removably secures within a recess 26 disposed in the upper wall 13, wherein the recess 26 is dimensioned to be in close tolerance with the latch 25 to frictionally engage the latch 25 therein. In alternate embodiments, the latch 25 is in operable communication with a button, whereupon actuation of the button disengages the latch 25 from the recess 26 to allow the lid 19 to be moved to the open position.

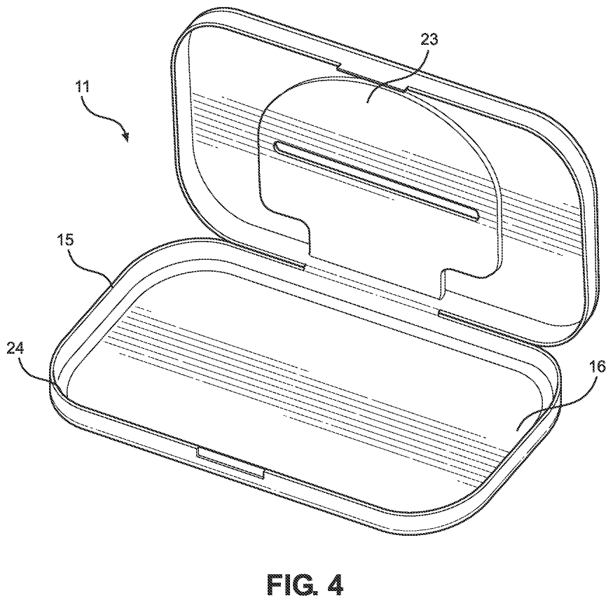

Referring now to FIG. 4, there is shown a perspective view of an embodiment of the glove dispensing container in an open position. In the shown embodiment, the glove dispensing container 11 comprises a clamshell configuration comprising an upper portion 23 hingedly connected to a lower portion 24 along a rear side of the perimeter sidewall 15. In this manner, the container body can be placed in an open configuration as shown, thereby providing access to the interior volume 16. In this manner, the user can readily refill the glove dispensing container 11 with additional gloves as needed. In the shown embodiment, a clasp extends from the upper portion 23 and engages the lower portion 24 to retain the glove dispensing container 11 in a closed configuration. In some embodiments, when the glove dispensing container 11 is in the closed configuration, a watertight seal is formed along the interface between the upper portion 23 and the lower portion 24. In this manner, the interior volume 16 is protected from excess moisture, sunlight, or other effects that may cause the plurality of disposable gloves to degrade over time.

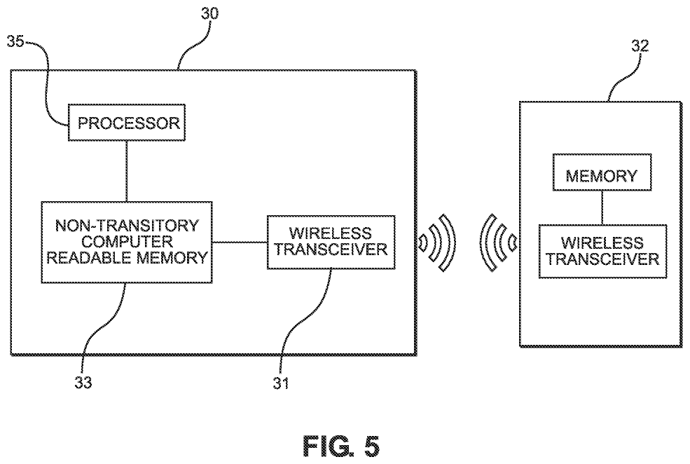

Referring now to FIG. 5, there is shown a schematic view of an embodiment of the display of the glove dispensing container. In the shown embodiment, the display 30 comprises a computing device including a processor 35 operably connected to a non-transitory computer readable memory 33 having a plurality of images, videos, or other media stored thereon, such that the user can select a desired media to display via an associated user interface. In some such embodiments, the processor 35 generates the user interface on the display 30, however, in the shown embodiment, the display 30 is further in wireless communication with a remote device 32 via a wireless transceiver 31 disposed within the display 30, such that the user can select the desired media to display via an application or user interface disposed on the remote device 32. In such embodiments, the remote device 32 can further transfer media to the non-transitory computer readable memory 33 for selective display. In this manner, the user can download or stream additional images or videos from a remote device 32, such as a smartphone, tablet, or other remote device, to the on-board memory 33 of the display 30 to further customize or entertain the user while the lid of the glove dispensing container is closed.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A glove dispensing container, comprising:
a container body having an upper wall, a lower wall, and a perimeter sidewall defining an interior volume;
a slot disposed centrally through the upper wall of the container body, wherein the slot provides access to the interior volume;
a plurality of disposable gloves disposed within the interior volume;
wherein the slot is dimensioned to dispense a disposable glove of the plurality of disposable gloves therethrough;
a lid hingedly affixed to a rear edge of the upper wall of the container body, wherein the lid selectively moves between an open position and a closed position;
wherein the closed position, the lid overlies the slot to enclose the interior volume;
indicia disposed across an exterior surface of the container body.

2. The glove dispensing container of claim 1, wherein the plurality of disposable gloves are interwoven in a stacked configuration, such that upon dispensing a disposable glove through the slot, an adjacent disposable glove is partially dispensed through the slot.

3. The glove dispensing container of claim 1, wherein the plurality of disposable gloves comprise a material configured to be chemically inert with respect to gasoline.

4. The glove dispensing container of claim 1, wherein the container body comprises an upper portion hingedly affixed to a lower portion.

5. The glove dispensing container of claim 1, further comprising a latch disposed on the lid, wherein the latch retains the lid in the closed position.

6. The glove dispensing container of claim 5, wherein the latch frictionally engages within a recess disposed within the upper wall of the container body.

7. The glove dispensing container of claim 5, further comprising a button disposed on the upper wall, whereupon actuation of the button the latch is disengaged.

8. The glove dispensing container of claim 1, further comprising a fastener on a lower surface of the lower wall, wherein the fastener removably secures the container body to a support surface.

9. The glove dispensing container of claim 1, wherein an upper surface of the lid rests flush with an exterior of the upper wall of the container body when the lid is in the closed position.

10. The glove dispensing container of claim 1, wherein the lid is disposed centrally along the upper wall and comprises a smaller cross-sectional area than the upper wall of the container body.

11. A glove dispensing container, comprising:
a container body having an upper wall, a lower wall, and a perimeter sidewall defining an interior volume;
a slot disposed centrally through the upper wall of the container body, wherein the slot provides access to the interior volume;
a plurality of disposable gloves disposed within the interior volume;
wherein the slot is dimensioned to dispense a disposable glove of the plurality of disposable gloves therethrough;
a lid hingedly affixed to a rear edge of the upper wall of the container body, wherein the lid selectively moves between an open position and a closed position;
wherein the closed position, the lid overlies the slot to enclose the interior volume;
a display disposed on an upper surface of the lid;
wherein the display includes a non-transitory computer readable medium and a wireless transceiver in wireless communication with a remote device;
wherein the non-transitory computer readable memory stores a plurality of images received from the remote device;
wherein the display is configured to display one or more selected images from the plurality of images.

12. The glove dispensing container of claim 11, wherein the plurality of disposable gloves are interwoven in a stacked configuration, such that upon dispensing a disposable glove through the slot, an adjacent disposable glove is partially dispensed through the slot.

13. The glove dispensing container of claim 11, wherein the plurality of disposable gloves comprise a material configured to be chemically inert with respect to gasoline.

14. The glove dispensing container of claim 11, wherein the container body comprises an upper portion hingedly affixed to a lower portion.

15. The glove dispensing container of claim 11, further comprising a latch disposed on the lid, wherein the latch retains the lid in the closed position.

16. The glove dispensing container of claim 15, wherein the latch frictionally engages within a recess disposed within the upper wall of the container body.

17. The glove dispensing container of claim 15, further comprising a button disposed on the upper wall, whereupon actuation of the button the latch is disengaged.

18. The glove dispensing container of claim 11, further comprising a fastener on a lower surface of the lower wall, wherein the fastener removably secures the container body to a support surface.

19. The glove dispensing container of claim 11, wherein an upper surface of the lid rests flush with an exterior of the upper wall of the container body when the lid is in the closed position.

20. The glove dispensing container of claim 11, wherein the lid is disposed centrally along the upper wall and comprises a smaller cross-sectional area than the upper wall of the container body.
